(19) United States
(12) Patent Application Publication
(10) Pub. No.: US 2010/0332283 A1
(43) Pub. Date: Dec. 30, 2010

(54) SOCIAL NETWORKING IN SHOPPING ENVIRONMENTS

(75) Inventors: Stanley Ng, Los Altos, CA (US); Christine Cho, Cupertino, CA (US); Monica Tran, Hayward, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/493,961

(22) Filed: Jun. 29, 2009

(51) Int. Cl. G06Q 30/00; G06Q 99/00; G06Q 10/00

(52) U.S. Cl. 705/9; 705/10; 705/27; 705/319; 705/347

(57) ABSTRACT

This is directed to a system and method for providing social networking services using a portable electronic device. In some embodiments, a user may identify one or more articles of interest and transmit identifying information for the articles to mobile or other devices of the user's friends. The user's friends can review the identified articles, and provide comments for the user. For example, the user's friends can give a thumbs up/down, a star rating, a comment (e.g., text, audio or video), or any other type of comment. In some embodiments, the user can request the assistance of a salesperson using the social networking application device, for example to request recommended articles based on a particular event or need. In some embodiments, the social networking application can provide information to or from a kiosk.

### BACKGROUND OF THE INVENTION

This is directed to providing social networking applications in shopping environments. In particular, this is directed to providing social networking applications operating on mobile devices by which users can share and receive information related to their shopping, such as purchase recommendations.

When shopping in brick and mortar stores, such as in a mall, some users like having friends with them to look at items to purchase (e.g., clothing), and to get their friends' recommendations and comments on proposed purchases. Similarly, some users rely on salespeople recommendations to select which items to purchase, or which items to try (e.g., which clothing or outfits to try on). These approaches, however, require the user to have their friends with them during the shopping trip, or require the users to catch the attention of a salesperson and ensure that the salesperson remains available during the shopping trip.

At other times, users may wish to meet up with friends at different points during a shopping trip. Although users can use text messaging, telephone calls, or other communications means to coordinate, these approaches can be time consuming and require complex coordination (e.g., several telephone calls before a group of users agrees on a meeting place and meeting time). In addition, the communications means can be limiting, in the sense that only some messages may be transmitted via the communications means (e.g., no images or video via telephone call, no immediate feedback via text message).

### SUMMARY OF THE INVENTION

This is directed to a system and method for providing social networking services in a shopping context in accordance with one embodiment of the invention. The social networking services provided can be used in other contexts, such as while traveling, out in the town, or other places that a user may go.

In a shopping environment, a user may identify one or more articles of interest. Before purchasing the articles, the user may wish to consult with friends or other people. To do so, the user can use a mobile device to transmit identifying information for the articles to mobile or other devices of the user's friends (e.g., some or all friends in an address book, or just friends located within a maximum distance of the user, for example in the same mall). The identifying information can include links to databases of the articles, images or photographs of the articles, location information for the friends to see the articles (e.g., identify a rack in a store where an article of clothing was found) or any other suitable information. The user's friends can review the identified articles, and provide comments for the user. For example, the user's friends can give a thumbs up/down, a star rating, a comment (e.g., text, audio or video), or any other type of comment.

In some embodiments, the user can receive recommendations of other articles to purchase instead of or in addition to the initially identified articles. For example, other users can provide identifying information for other articles available for purchase. As another example, other users can identify other articles already owned by the user that would go well with articles available for purchase (e.g., articles previously identified by the user, or articles identified by other users). The received recommendations can include comments to assist the user in determining whether to make a purchase. The recommendations provided by friends can include articles available in the store in which the user is shopping, in other stores (e.g., in the same complex or mall), online or from remote sources (e.g., links to an online store or to a catalog from which articles can be ordered) or from any other suitable source.

In some embodiments, the user can request the assistance of a salesperson using the electronic device. For example, the user can provide one or more articles to a salesperson for comment, request recommended articles based on user-selected articles, or request recommended articles based on a particular event or need (e.g., request recommendations for an outfit suitable for a night out). Using an electronic device, the salesperson can review the request received from the user, and send proposed articles to the user for review. In some embodiments, the salesperson can bring proposed articles to the user, or place articles in a changing room for the user to try.

In addition to sending and receiving communications directly with friends or salespersons, the social networking application can provide information to or from a kiosk. The kiosk can include communications circuitry for receiving information from individual users' electronic devices, and storage for storing received information. Using an electronic device, a user can provide information identifying articles of interest to the kiosk. Other users can then retrieve the information from the kiosk, and provide comments or other recommendations directly to the user or to the kiosk. The user can then retrieve the recommendations from the kiosk at a later time.

In some embodiments, the kiosk can include a display and input interface by which users can interact with the kiosk. For example, users can direct the kiosk to display information for review. Using the input interface, users can provide recommendations, or identify other articles available for purchase by the user (e.g., surf the Internet using the kiosk, or navigate through catalogs of articles offered for sale by stores in the vicinity of the kiosk).

Each user can limit the access of information provided to the kiosk. For example, the user can require a password, key or other authentication information for viewing uploaded information. As another example, the user can limit the users who can provide feedback or recommendations to the user (e.g., only friends from a friend network can provide feedback). Alternatively, the user can limit access or feedback based on the manner in which the information is accessed (e.g., allow remote viewing of the uploaded information, but only allow recommendations provided using the input interface of the kiosk).

Each user can upload any suitable information to the kiosk. For example, the user can upload identifying information for one or more articles, polling requests (e.g., which outfit is better), videos, photographs, or other user generated content, meeting information (e.g., when and where to meet the user's friends that are in the same location), or any other type of information.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of an illustrative electronic device for providing a social networking application in accordance with one embodiment of the invention;

FIG. 2 is a schematic view of a networked kiosk and electronic device system in accordance with one embodiment of the invention;

FIG. 3 is a schematic view of an illustrative display for providing information identifying an article to a user's social network in accordance with one embodiment of the invention;

FIG. 4 is a schematic view of an illustrative display for responding to information received from a social network contact in accordance with one embodiment of the invention;

FIG. 5 is a flowchart of an illustrative process for requesting feedback from a social network in accordance with one embodiment of the invention; and

FIG. 6 is a flowchart of an illustrative process for receiving feedback from a social network in accordance with one embodiment of the invention.

### DETAILED DESCRIPTION

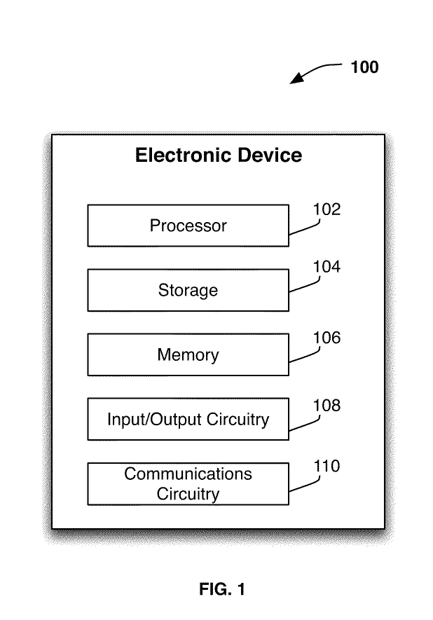

FIG. 1 is a schematic view of an illustrative electronic device for receiving the output of one or more sensors in accordance with one embodiment of the invention. Electronic device 100 can include control circuitry 102, storage 104, memory 106, input/output circuitry 108, and communications circuitry 110. In some embodiments, one or more of electronic device components 100 can be combined or omitted (e.g., combine storage 104 and memory 106). In some embodiments, electronic device 100 can include other components not combined or included in those shown in FIG. 1 (e.g., motion detection components, a power supply such as a battery or kinetics, a display, bus, or input mechanism), or several instances of the components shown in FIG. 1. For the sake of simplicity, only one of each of the components is shown in FIG. 1.

Control circuitry 102 can include any processing circuitry or processor operative to control the operations and performance of electronic device 100. For example, control circuitry 100 can be used to run operating system applications, firmware applications, media playback applications, media editing applications, or any other application. In some embodiments, the control circuitry can drive a display and process inputs received from a user interface.

Storage 104 can include, for example, one or more storage mediums including a hard-drive, solid state drive, flash memory, permanent memory such as ROM, any other suitable type of storage component, or any combination thereof. Storage 104 can store, for example, media data (e.g., music and video files), application data (e.g., for implementing functions on device 100), firmware, user preference information data (e.g., media playback preferences), authentication information (e.g. libraries of data associated with authorized users), lifestyle information data (e.g., food preferences), exercise information data (e.g., information obtained by exercise monitoring equipment), transaction information data (e.g., information such as credit card information), wireless connection information data (e.g., information that can enable electronic device 100 to establish a wireless connection), subscription information data (e.g., information that keeps track of podcasts or television shows or other media a user subscribes to), contact information data (e.g., telephone numbers and email addresses), calendar information data, and any other suitable data or any combination thereof.

Memory 106 can include cache memory, semi-permanent memory such as RAM, and/or one or more different types of memory used for temporarily storing data. In some embodiments, memory 106 can also be used for storing data used to operate electronic device applications, or any other type of data that can be stored in storage 104. In some embodiments, memory 106 and storage 104 can be combined as a single storage medium.

Input/output circuitry 108 can be operative to convert (and encode/decode, if necessary) analog signals and other signals into digital data. In some embodiments, input/output circuitry 108 can also convert digital data into any other type of signal, and vice-versa. For example, input/output circuitry 108 can receive and convert physical contact inputs (e.g., from a multi-touch screen), physical movements (e.g., from a mouse or sensor), analog audio signals (e.g., from a microphone), or any other input. The digital data can be provided to and received from processor 102, storage 104, memory 106, heart sensor 112, or any other component of electronic device 100. Although input/output circuitry 108 is illustrated in FIG. 1 as a single component of electronic device 100, several instances of input/output circuitry can be included in electronic device 100.

Electronic device 100 can include any suitable interface or component for allowing a user to provide inputs to input/output circuitry 108. For example, electronic device 100 can include any suitable input mechanism, such as for example, a button, keypad, dial, a click wheel, or a touch screen. In some embodiments, electronic device 100 can include a capacitive sensing mechanism, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to communications device with a wire or wirelessly).

In some embodiments, I/O circuitry 108 can include display circuitry (e.g., a screen or projection system) for providing a display visible to the user. For example, the display circuitry can include a screen (e.g., an LCD screen) that is incorporated in electronics device 100. As another example, the display circuitry can include a movable display or a projecting system for providing a display of content on a surface remote from electronic device 100 (e.g., a video projector). In some embodiments, the display circuitry can include a coder/decoder (Codec) to convert digital media data into analog signals. For example, the display circuitry (or other appropriate circuitry within electronic device 100) can include video Codecs, audio Codecs, or any other suitable type of Codec.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 102. Alternatively, the display circuitry can be operative to provide instructions to a remote display (e.g., display 130, FIG. 1).

Communications circuitry 110 can include any suitable communications circuitry operative to connect to a communications network and to transmit communications (e.g., voice or data) from communications device 100 to other devices within the communications network. Communications circuitry 110 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

In some embodiments, communications circuitry 110 can be operative to create a communications network using any suitable communications protocol. For example, communications circuitry 110 can create a short-range communications network using a short-range communications protocol to connect to other devices. For example, communications circuitry 110 can be operative to create a local communications network using the Bluetooth® protocol to couple electronic device 100 with a Bluetooth® headset.

Electronic device 100 can include one more instances of communications circuitry 110 for simultaneously performing several communications operations using different communications networks, although only one is shown in FIG. 1 to avoid overcomplicating the drawing. For example, electronic device 100 can include a first instance of communications circuitry 110 for communicating over a cellular network, and a second instance of communications circuitry 110 for communicating over Wi-Fi or using Bluetooth®. In some embodiments, the same instance of communications circuitry 110 can be operative to provide for communications over several communications networks.

In some embodiments, electronic device 100 can be coupled a host device for data transfers, synching the communications device, software or firmware updates, providing performance information to a remote source (e.g., providing riding characteristics to a remove server) or performing any other suitable operation that can require electronic device 100 to be coupled to a host device. Several electronic devices 100 can be coupled to a single host device using the host device as a server, and instead or in addition electronic device 100 can be coupled to several host devices (e.g., for each of the plurality of the host devices to serve as a backup for data stored in electronic device 100). In some embodiments, the communications circuitry can be used to connect to a kiosk (e.g., a kiosk used for social networking applications).

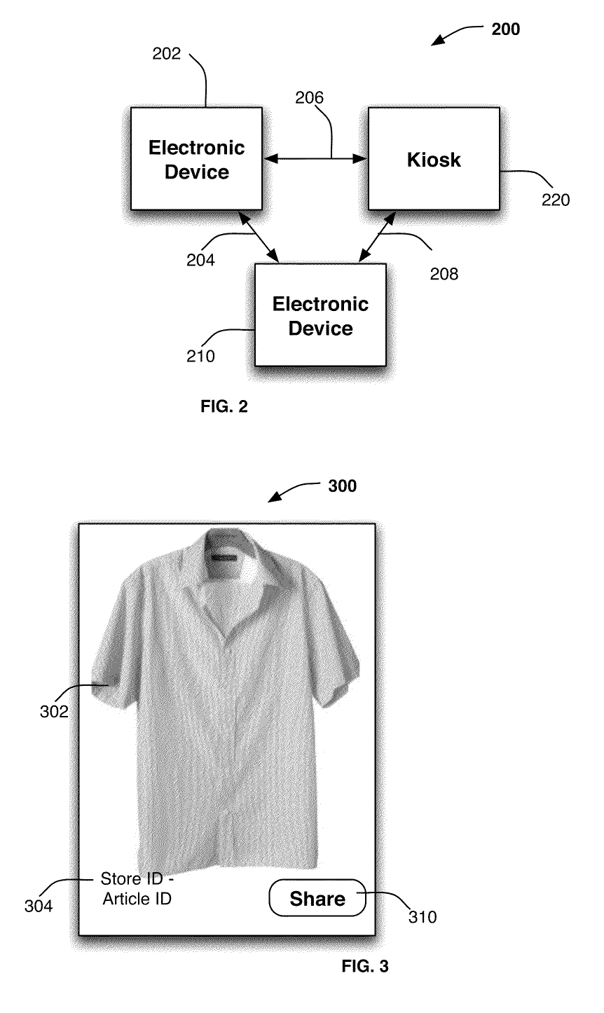

FIG. 2 is a schematic view of a networked kiosk and electronic device system in accordance with one embodiment of the invention. System 200 can include electronic devices 202 and 210, and kiosk 220. Each electronic device 202 and 210 can include some or all of the features of electronic device 100 (FIG. 1). Kiosk 220 can include any suitable electronic device operative to receive and store information from an electronic device. In some embodiments, kiosk 220 can include a processor, memory, storage, I/O circuitry (e.g., associated with a display and an input interface), and communications circuitry. The components of kiosk 220 can include some or all of the features of the corresponding components of the electronic devices (e.g., described above in connection with FIG. 1). Although only two electronic devices and one kiosk are shown in FIG. 2, it will be understood that any suitable number of electronic devices and kiosks can be used in a networked system.

Kiosk 220 may be operative to receive and store any suitable information received from an electronic device. For example, kiosk 220 can be operative to receive information identifying articles available for purchase by a user. As another example, kiosk 220 can be operative to receive user generated content (e.g., videos, photos, combinations of articles). In some embodiments, kiosk 220 can limit access to uploaded content based on any suitable criteria. For example, kiosk 220 can include several user accounts or user profiles with which content can be associated. Each user can then select the manner in which content associated with the account is made available. For example, content can be made available to all users or a subset of users (e.g., the user's friends in a social network). As another example, the kiosk can provide different levels of access to the content associated with each user's account (e.g., different combinations of read, write and comment access).

The different components of system 200 can communicate via communications paths 204, 206 and 208. Communications paths 204, 206 and 208 can include any suitable wired or wireless communications paths, including for example using one or more of the protocols described above in connection with electronic device 100. In some embodiments, the communications provided via communications paths 204, 206 and 208 can be encrypted or secured such that only authorized devices can access the communications, or to ensure that polls or other interactive features are not manipulated.

Using a social networking application, a user can share information with friends or other electronic device users. For example, the user can send messages, request recommendations or other communications to other users. In particular, the social networking application may be particularly effective for requesting feedback or comments from different users in particular contexts, such as when shopping. The social networking application can be used to communicate directly with the electronic devices of other users, or alternatively can provide information to a central location (e.g., a kiosk). Although the following discussion will illustrate the use of a social networking application in the context of shopping (e.g., in a mall), it will be understood that the described embodiments can be applied to any suitable context in which a social networking application may be used.

A user can share any suitable information with friends or other users using a social networking application. In particular, a user can share different information with friends while shopping, and request information back from the friends. To enhance the user's shopping experience, the user can share shopping related information with the user's friends. Such information can include, for example, information identifying articles of interest to the user, specific requests for types of articles, a situation or context for which a purchase is necessary (e.g., identify a party for which the user needs an outfit, or identify the age and sex of a child for which a birthday present is needed), or any other information defining what a user likes or what a user wishes to find.

The user can identify articles available for purchase using any suitable approach. In some embodiments, the user can provide a link to a remote database describing the article (e.g., a hyperlink to a website), a written description of the article, audio, a photograph or video of the article, or any other suitable information for describing the article. In some embodiments, the user can capture audio, images or video of the article using a microphone and/or a camera lens of the electronic device. FIG. 3 is a schematic view of an illustrative display for providing information identifying an article to a user's social network in accordance with one embodiment of the invention. Display 300 can include image 302 and description 304 of an article of interest to the user. The user can generate image 302 using any suitable approach, including for example capturing an image or video using a camera lens, retrieving an image from a database or other remote source, or any other suitable approach. Image 302 can include one or more still images, videos, or both. Field 304 can include a description of the article, comments regarding the article (e.g., explaining why the user is interested in the article), a retrieved description from a database or remote server, or any other suitable approach to generate a description of the article. In some embodiments, the user can capture or enter a barcode or link associated with the article in the shop (e.g., a barcode on the article tag), where the link directs the device to retrieve an image or video, description, or both.

The user can send the identifying information to the user's social network using any suitable approach. In some embodiments, the user can provide an instruction by selecting a displayed option (e.g., share option 310). The user can share information with any suitable person, including for example some or all of the user's friends on a social network, the user's contacts (e.g., retrieved from an address book), users of other devices in communication with the user's device (e.g., other devices on the same short-range communications network as the user's electronic device), or any other suitable set of users. The user can select the target users to which to send the information using any suitable approach, including for example by selecting specific users or sets of users from a listing (e.g., a contacts listing) displayed in response to receiving the user selection of option 310. In some embodiments, the user can instead or in addition publish the information to a remote server, kiosk, or other remote device to which members of the user's social network can log in and view the posted information.

Upon receiving information from the user, a target use can provide any suitable response to the user. For example, the target user can provide feedback regarding the particular article (e.g., an opinion regarding the purchase of the article, or a star rating), respond to a poll or question posed by the user (e.g., does this shirt go well with another article of clothing in the user's closet), or any other feedback related to the particular identified article. In some embodiments, the target user can instead or in addition identify another article available for purchase that the user should consider instead. For example, the target user can identify a similar article available from another store, online, or from a catalog, or identify a different article to purchase instead (e.g., an article that is more fashionable). As another example, the target user can identify an article currently owned by the user, target user, or another person that the user can borrow or rent instead of purchasing a new article).

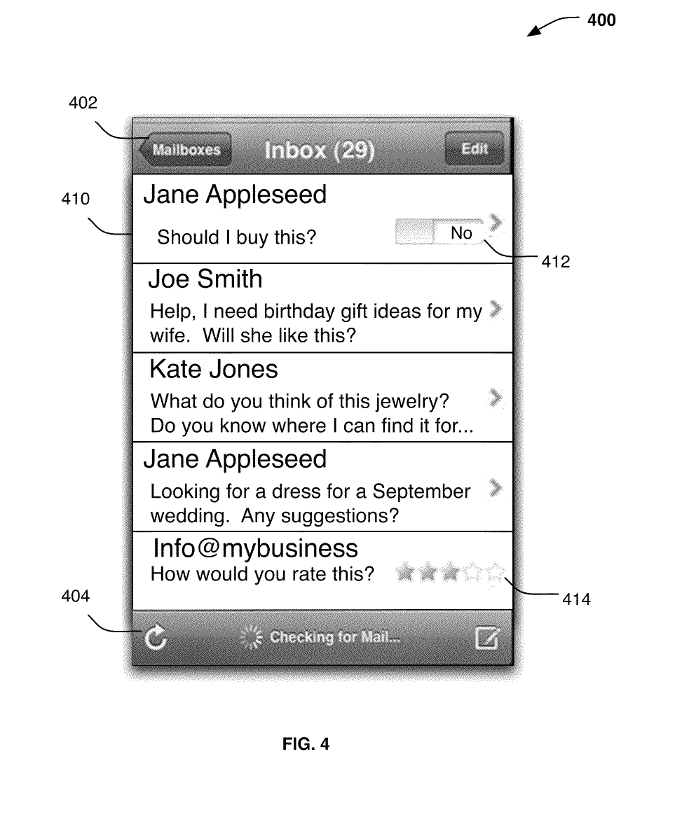

The target user can respond to a request for information using any suitable approach. FIG. 4 is a schematic view of an illustrative display for responding to information received from a social network contact in accordance with one embodiment of the invention. Display 400 can include control bars 402 and 404 for navigating the application display, and listing 410 of messages received from other users of the user's social network. To view a message, the user can select a corresponding listing, in response to which the electronic device can display the message with options for responding. In some embodiments, the target user can receive a message requesting a yes/no answer or a rating (e.g., a star rating), for example as part of a poll. In response to such requests, display 400 can include options for responding embedded within listings 410. For example, listings 410 can include toggle option 412 for responding to binary questions (e.g., should I buy this) and star option 414 for providing a response within a range of available responses (e.g., rate an article that the user wants to buy). In some embodiments, listings 410 can include a field into which a user can input short responses (e.g., a field for inputting a numerical rating). The target user can provide any suitable type of response, including for example text, audio, an image, a video (e.g., target user-generated), or any other type of response.

Upon receiving responses from one or more target users, the user can decide whether or not to purchase the initially identified article, look at new articles (e.g., new articles identified by the target users), or delay a decision (e.g., so that one or more target users can come in person to give additional feedback to the user).

In addition to requesting feedback or other assistance from a user's social network (e.g., the user's friends), the user can also request assistance from employees of a store or other customers or people located in the vicinity of the user. In particular, a user can request assistance from a salesperson in the store using the electronic device. This can allow a single salesperson, using an electronic device that is in communication with several customers, to simultaneously field several requests from the customers. This approach may therefore be of interest when many customers are in a store requiring assistance, and there are too few salespeople available to simultaneously assist each customer.

A user can identify the electronic devices associated with salespeople using any suitable approach. In some embodiments, the user can connect to a communications network provided by the store in which the user is located, or a communications network covering the store and to which electronic devices of the store employees are connected, and identify the other electronic devices on the same network. The electronic devices of salespeople can broadcast a particular identifier or other information indicating that they are associated with salespeople, so that a user can direct inquiries to those devices. In some embodiments, the inquiries can be secured, for example using a key provided by store employees to customers.

The user can send any suitable requests to salespeople to enhance the shopping experience. For example, a user can specify a context for which a purchase is necessary, and request recommendations from a salesperson (e.g., send a request indicating that a gift for a person of a particular age is needed). As another example, the user can request recommendations for a particular type of article (e.g., send a request for dark shirts in a medium size). As still another example, a user can specify particular articles of interest (e.g., and request that the articles be placed in a changing room for trying on). Using an electronic device, a salesperson can receive, review and respond to the requests sent by different customers (e.g., using a display similar to display 300, FIG. 3).

In response to receiving a request from a user, a salesperson can provide a personalized response to each customer. For example, the salesperson can review the articles available for sale by the store (e.g., from an internal database identifying the sizes and models that are in stock) and provide each user with links or information identifying specific articles of interest. As another example, the salesperson can identify articles of interest in the store, capture photographs or video of the articles, and send the captured media to a user. The user can then indicate whether the articles identified by the salesperson are of interest, and request that the articles of interest be brought to the user (e.g., place clothing in a changing room to be tried on).

The salesperson can provide any suitable communication or response to a user request that is received via a social networking application on the salesperson's electronic device. For example, the salesperson can provide a reply communication with a response to a question or poll posed by the user. As another example, the salesperson can seek out a particular user to provide in-person assistance. As still another example, the salesperson can remotely check out a user, for example by receiving and processing payment information (e.g., a credit card number) from the user.

Using the social networking application, a user can provide information directly to the user's social network, or can instead or in addition provide information to a central server or device to which other users of the social network can connect to view the information posted by the user. In some embodiments, the electronic device can connect to kiosk to upload different content. The electronic device can upload any suitable content to a kiosk, including for example user-generated content, content describing articles or services available for purchase by the user, or any other suitable content. For example, the user can provide the information described above in connection with FIG. 3.

The kiosk can be placed at any suitable location. In some embodiments, the kiosk can be placed within a known geographic area (e.g., within a shopping complex). The kiosk can be associated with the geographic location, for example by limiting the range of the kiosk communications circuitry such that the electronic devices of users wishing to upload content to the kiosk or retrieve content from the kiosk may need to be within a particular distance from the kiosk. This can ensure that content and requests sent to the kiosk are location sensitive (e.g., requests to meet in the shopping center are only received if the user sending the request is already at the shopping center).

A user can limit access to content provided to the kiosk using any suitable approach. In some embodiments, the user can associate uploaded content with a user account of the kiosk. For example, the kiosk can include several user accounts each associated with authentication information for tying uploaded content to specific users. Each account can include access limitations or other information describing who may access uploaded content, and what different users can do with the content. For example, the user account can include read and write settings. In some embodiments, the user can associate different privileges to different content. This can allow the user to upload different instances of content while ensuring that each instance of content is only accessible to the desired target users.

Target users can access content from the kiosk using any suitable approach. In some embodiments, the target users can remotely connect to the kiosk over an appropriate communications network, and remotely retrieve uploaded content. For example, a target user can log in or authenticate to the kiosk, and request access to content uploaded by others (e.g., access content uploaded by users of the target user's social network, or access content associated with a key provided by the target user, where an uploading user provides the key to the target user). After retrieving content retrieved from the kiosk, the user can upload a response to the kiosk, where the response is linked with the initial user's account. This can allow the initial user to, at a later time, connect to the kiosk to review all of the responses provided by the initial user's social network.

In some embodiments, a target user can instead or in addition use an input interface and display of the kiosk to access content uploaded to the kiosk. The user may be required to authenticate prior to using the kiosk, for example, by entering a user name and password, passkey, or other personal information. In some embodiments, the passkey can be associated with specific content uploaded to the kiosk. The user can then access content using the display or other I/O circuitry of the kiosk, and provide response using the input interface. The responses can be stored on the kiosk, sent directly to the electronic device of the user requesting the response, or any other electronic device.

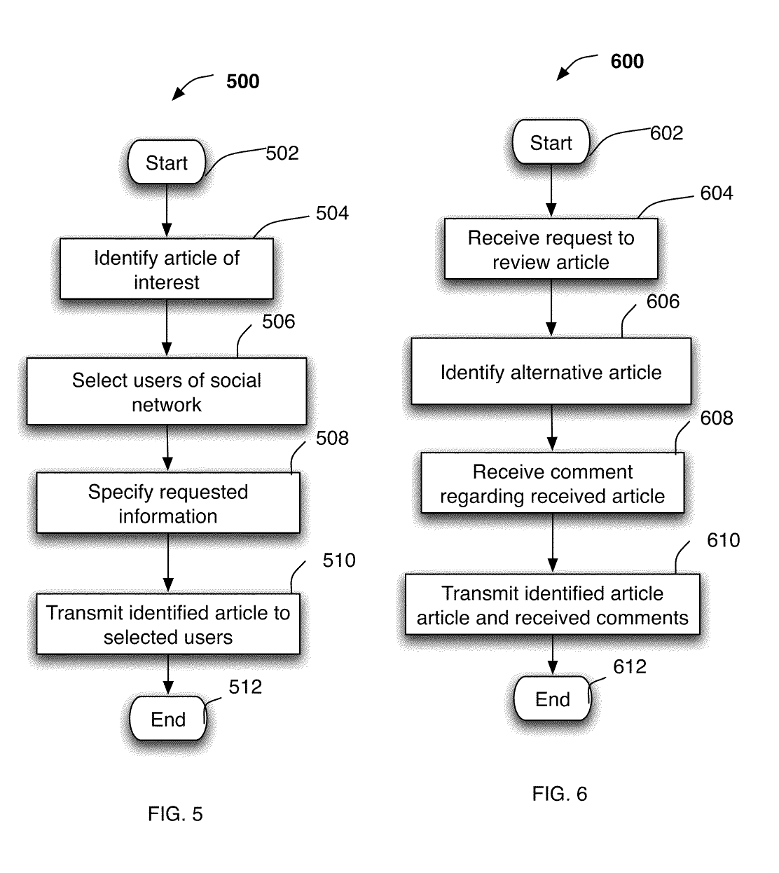

FIG. 5 is a flowchart of an illustrative process for requesting feedback from a social network in accordance with one embodiment of the invention. Process 500 can begin at step 502. At step 504, a user can identify an article of interest using an electronic device. For example, the user can retrieve identifying information for an article available for purchase. As another example, the electronic device can be used to capture an image or video of the article. At step 506, the electronic device can receive a selection users of a social network. For example, the user can select some or all of the friends or target users of a social network. As another example, the user can select particular users or electronic devices sharing a communications network the user device. As still another example, the user can select one or more kiosks or other publicly accessible remote servers.

At step 508, the electronic device can receive a specified request for information. For example, a user may pose a question to the selected users (e.g., do the users like the identified article). As another example, the user can generate a poll to which the selected users may respond. As still another example, the user can request general feedback. At step 510, the electronic device can transmit information identifying the article and the specified request to the selected users. For example, the electronic device can use a dedicated application (e.g., a social networking application) to transmit the communication. Process 500 can then end at step 512.

FIG. 6 is a flowchart of an illustrative process for receiving feedback from a social network in accordance with one embodiment of the invention. Process 600 can begin at step 602. At step 604, the electronic device can receive a request to review an article identified by another device. For example, the electronic device can receive a request generated using process 500 (FIG. 5). At step 606, the electronic device can identify an alternate article that may be of interest to the user that identified the received article. For example, the electronic device can identify a similar article, or a different article that the user finds may be of interest.

At step 608, the electronic device can receive comments regarding the received article. For example, the electronic device can receive a user input providing comments. At step 610, the electronic device can transmit information identifying the alternate article and the received comments. For example, the electronic device can transmit the information and comments to the device of the user having provided the received article, to a kiosk or remote server, or to any other suitable device. Process 600 can then end at step 612.

Although many of the embodiments of the present invention are described herein with respect to personal computing devices, it should be understood that the present invention is not limited to personal computing applications, but is generally applicable to other applications.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above-described embodiments of the present invention are presented for purposes of illustration and not of limitation, and the present invention is limited only by the claims which follow.

What is claimed is:

1. A method for providing social networking services in a shopping context, comprising:
retrieving information identifying an article available for sale that is of interest to a user;
receiving an input defining a request relative to the article, wherein the request requires a response from other users;
providing the retrieved information and received request to a remote kiosk, wherein the kiosk is accessible to the other users and is within a maximum distance from the user.

2. The method of claim 1, further comprising:
receiving a listing of target users to whom to provide the retrieved information and received request.

3. The method of claim 2, wherein:
the target users are part of the user's social network.

4. The method of claim 1, wherein retrieving further comprises:
capturing at least one of an image and a video of the article using a camera lens.

5. The method of claim 1, wherein retrieving further comprises:
identifying the article; and
retrieving information related to the article from a remote database via a communications network.

6. The method of claim 1, wherein retrieving further comprising retrieving at least one of:
an image of the article;
a video of the article;
audio related to the article; and
text.

7. The method of claim 1, wherein receiving further comprises:
receiving a poll to pose to the target users, wherein the poll responses comprise a multiple choice.

8. The method of claim 1, further comprising:
receiving, from at least one of the other users, a response to the request, wherein the response comprises at least one of:
a binary response;
a multiple choice response; and
comments regarding the article.

9. An electronic device operative to communicate with a social network, comprising control circuitry and communications circuitry, the control circuitry operative to:
identify an article available for purchase by a user;
identify at least one target user of the user's social network, wherein the at least one target user is in the vicinity of the user;
direct the communications circuitry to transmit information defining the identified article to a kiosk; and
direct the communications circuitry to receive a response from the kiosk, wherein the response comprises a recommendation for an alternate article to purchase, the response generated by the at least one target user.

10. The electronic device of claim 9, wherein the control circuitry is further operative to:
direct the communications circuitry to retrieve information related to the article from a remote database; and
direct the communications circuitry to transmit the retrieved information to the kiosk.

11. The electronic device of claim 9, wherein the control circuitry is further operative to:
identify an electronic device associated with a salesperson of the store selling the article; and
direct the communications circuitry to transmit a request for assistance to the electronic device associated with the salesperson.

12. The electronic device of claim 11, wherein the control circuitry is further operative to:
define a request for assistance based on a context for which the user is shopping.

13. A method for communicating with a salesperson via a social networking application in a shopping context, comprising:
receiving a context for which an article is to be purchased;
identifying at least one electronic device associated with the salesperson;
providing the received context to the identified electronic device; and
receiving, from the identified electronic device, a recommendation of an article to purchase that is appropriate for the received context.

14. The method of claim 13, wherein providing further comprises:
describing a person for which the article is to be purchased.

15. The method of claim 13, wherein providing further comprises:
describing an event for which the article is to be used.

16. The method of claim 15, wherein:
the event comprises a social event; and
the article comprises an article of clothing.

17. The method of claim 13, further comprising:
receiving, from the identified electronic device, a communication specifying where to find the recommended article in the store.

18. A kiosk for use with a social networking application, comprising control circuitry, an input interface, and communications circuitry, the control circuitry operative to:
direct the communications circuitry to receive information identifying an article and a request from a first electronic device;
provide the received article and request to members of a social network associated with the first electronic device that are within a predetermined distance from the kiosk;
receive a response from at least one member of the social network; and
direct the communications circuitry to provide the received response to the first electronic device.

19. The kiosk of claim 18, wherein the control circuitry is further operative to:
direct the input interface to receive the response.

20. The kiosk of claim 18, wherein the control circuitry is further operative to:
direct the communications circuitry to receive the response from a second electronic device associated with the at least one member of the social network.

21. The kiosk of claim 18, wherein the control circuitry is further operative to:
identify an account associated with the first electronic device;
associate the received article and request with the identified account; and
limit access to the received article and request based on the identified account settings.
